(19) United States
(12) Patent Application Publication
(10) Pub. No.: US 2003/0233501 A1
(43) Pub. Date: Dec. 18, 2003

(54) Device for transferring from a memory card interface to a universal serial bus interface

(75) Inventors: Chung Hsun Ma, Hsin Chu (TW); Tse Cheng, Hsin Chu (TW)

Correspondence Address: BACON & THOMAS, PLLC, 625 SLATERS LANE, FOURTH FLOOR, ALEXANDRIA, VA, 22314

(73) Assignee: Kingbyte Information Corp., Hsin Chu (TW)

(21) Appl. No.: 10/227,871

(22) Filed: Aug. 27, 2002

(30) Foreign Application Priority Data
Jun. 18, 2002 (TW) 091209117

(51) Int. Cl. G06F 13/12

(52) U.S. Cl. 710/62

(57) ABSTRACT

A device is proposed for transferring from a memory card interface to a USB (Universal Serial Bus) interface. There are a universal I/O device able to simulate signals from a memory card interface; a micro controller able to control the universal I/O device to access the data in the memory card and to generate a USB data package; a USB serial interface engine able to transfer the USB data package from the micro controller to a serial data stream; and a USB transfer/receive device able to connect to a USB storage device and to transfer the serial data stream to a USB electrical signal.

### FIELD OF THE INVENTION

The present invention is relative to a device for transferring from a memory card interface to a USB (Universal Serial Bus) interface. By this device we may transfer the data from a memory card to a USB storage device directly.

### BACKGROUND OF THE INVENTION

The popular memory cards in current market include CF (Compact Flash), Micro Drive, SD (Secure Digital), MS (Memory Stock), MMC (Multimedia Card), and SM (Smart Media), etc. These memory cards are usually used in the IA (Information Appliance) products such as PDA (Personal Digital Assistant), Digital Camera, MP3 Player, Digital Video Camera, and so on. The storage capacity can be 8 MB, 16 MB, 32 MB, or 64 MB, to store and access a numbers of voice or image data according to the user's requirement.

For example, the memory card of a Digital Camera can store the photo pictures, and after photographed the user can tale the memory card out and save the pictures into a computer. Due to the storage capacity limitation of a memory card, the storage space can't store many pictures. Of course, a user would buy some pieces of memory cards for backup but these memory cards are not cheap.

The storage space of a small size but large capacity storage device for USB interface (just likes the 2.5″ USB hard disk) would reach several Giga Bytes (1 Giga=1000 Mega). The most advantage of this product is easy to carry, but it can connect to a computer only. Because this storage product cannot connect to the USB interface of a digital camera, so the data stored in the memory card cannot be transferred to store into this USB storage device directly.

Due to the architecture of USB is a “Master/Slave” relationship, only the “Master” device can access the data stored in the “Slave” device. And, the USB “Master” device that is mainly designed for the computer is very complex, so it is not used in the portable devices especially with small size and low electric energy (just likes a digital camera). Therefore, the portable devices with memory card interfaces (just likes CF or SD) cannot access the application devices with USB interfaces.

In other words, the reason why a computer is able to control every USB device is that the computer is a USB host, and a general USB device is a slave device only but not a host. Therefore, a digital camera and a USB hard disk are both USB devices, but they still cannot transfer data to each other without a host.

So, if the data stored in a memory card can be transferred to save into a portable USB storage device with a large space without a computer, a user will never worry about the capacity limitation of a memory card when using a digital camera (or other information appliances). Whenever the storage space of a memory card is full, the user can transfer picture data into a USB hard disk immediately and keep on using the memory card.

Purpose of the Invention

The main purpose of the present invention is to design a device for transferring data from a memory card interface to a USB interface. The device has a host function able to control the USB storage devices and transfer the data stored in a memory card into a USB storage device. Therefore, it is very convenient to transfer data in the memory card into a USB storage device of a large storage space when one uses the portable IA with a memory card. So, the limitation of a memory card storage space is no more a problem.

### SUMMARY OF THE INVENTION

According to the present invention, the present invention provides a device for transferring from a memory card interface to a USB (Universal Serial Bus) interface, which contains:

A Universal I/O Device for simulating the signal of a memory card interface;

A Micro Controller for controlling the universal I/O device to access the data in the memory card, and generating a USB data package;

A USB Serial Interface Engine for transferring the USB data package generated by the micro controller to a serial data stream; and

A USB Transfer/Receive Device for connecting to a USB storage device, and transferring the serial data stream into a USB electrical signal.

In accordance with one aspect of the present invention, the memory card includes: CF (Compact Flash), Micro Driver, SD (Secure Digital), MS (Memory Stock), MMC (Multimedia Card), and SM (Smart Media), etc.

In accordance with one aspect of the present invention, the micro controller operates as below:

Receiving a command and a data of the memory card interface, proceeding an analysis and transferring them to a USB data package;

Controlling the USB serial interface engine to transfer or receive the USB data package;

Executing a necessary error manage procedure for USB;

Executing the initialization for the USB storage device; and

Controlling several I/O devices of I/O ports to meet the interface specification requirement for the memory card.

In accordance with one aspect of the present invention, the USB serial interface engine operates as below:

Transferring the serial data stream received by the USB transfer/receive device to the USB data package.

In accordance with one aspect of the present invention, the USB transfer/receive device operates as below:

Transferring the USB electrical signal to the serial data stream.

In accordance with one aspect of the present invention, the USB storage device includes a USB hard disk, a USB flash disk, a USB floppy disk, and a USB CD-RW, and so on.

The present invention may best be understood through the following description with reference to the accompanying drawings, in which:

### BRIEF DESCRIPTION OF THE DRAWINGS

FIG. 1(A) is the system block diagram according to the present invention.

FIG. 1(B) is the hardware architecture block diagram according to the present invention.

FIG. 2 is the controlling flowchart according to the present invention.

FIG. 3 is the initialization control flowchart according to the present invention.

### DETAILED DESCRIPTION OF THE PREFERRED EMBODIMENT

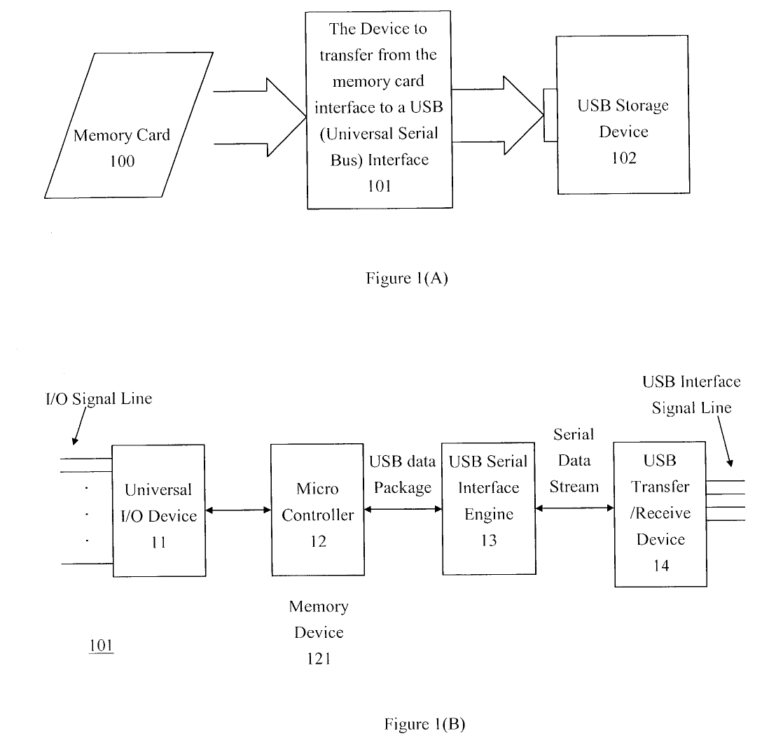

FIG. 1(A) shows the system block diagram according to the present invention. The Memory Card 100 connects to the Device 101 of the present invention for storing data to USB storage device 102.

For example, the Device 101 is able to transfer the signal and protocol for CF or SD interface to the signal and protocol for USB interface respectively. Therefore, the device designed for CF or SD storage media (such as a digital camera) can store data into storage device for USB interface.

FIG. 1(B) shows the hardware block diagram according to the present invention. This device contains a Universal I/O Device 11, a Micro Controller 12, a USB Serial Interface Engine 13, and a USB Transfer/Receive Device 14.

The main functions of the Micro Controller 12 are:

1. Receiving commands or data from CF or SD interface, analyzing them and transferring them into USB data packages of USB specification.

2. Controlling the USB serial interface engine to transfer or receive the USB data package.

3. Executing the necessary error manage procedure for USB.

4. Executing the initialization for USB device.

5. Controlling a numbers of I/O devices of I/O ports to meet the specification of CF or SD interface.

The main function of the USB serial interface engine 13 is to transfer the USB data package prepared by the micro controller 12 to the serial data stream, and transfer the serial data stream received by the USB transfer/receive device to the USB data package.

The main function of the USB transfer/receive device 14 is to transfer the serial data stream to the USB electrical signal, or transfer the received USB electrical signal to the serial data stream.

The main function of the memory device 121 is to store the program and control parameters of the micro controller.

The main function of the universal I/O device 11 is to provide several I/O ports, and simulate the interface signals of CF or SD via the control of the micro controller.

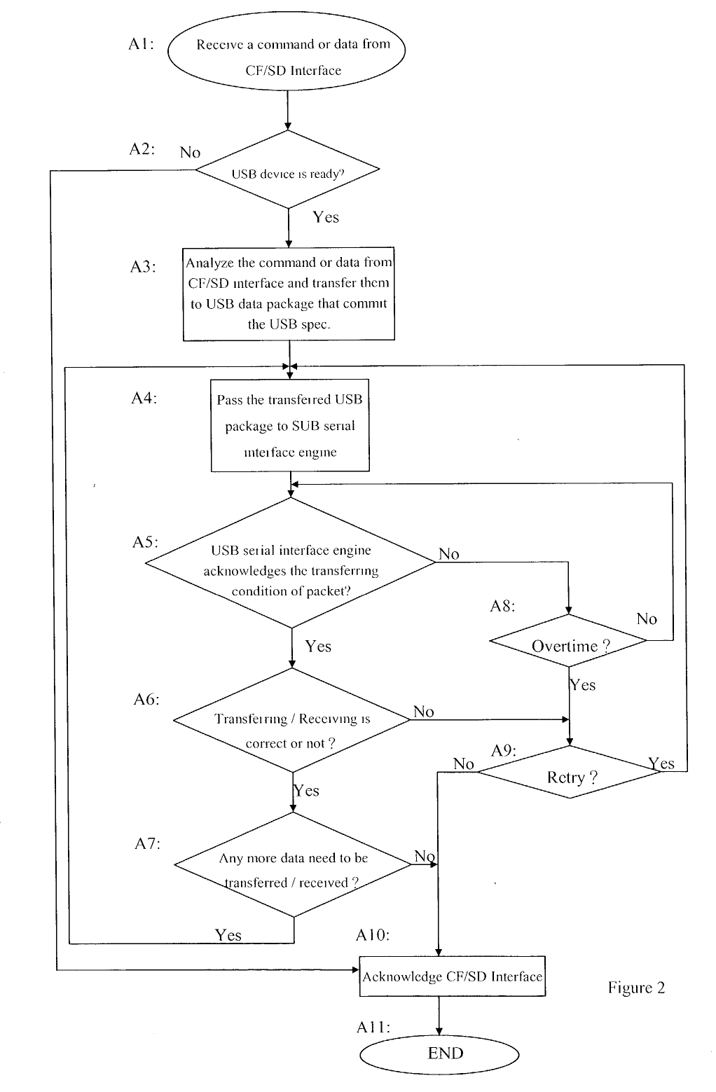

FIG. 2 shows the control flowchart of CF or SD interface and USB interface according the present invention, which includes steps of:

A1: Beginning to act after receiving a command or data from CF or SD interface.

A2: Checking the USB storage device is ready or not: if ready, then run the next step; if not, then jump to step A10, reply to CF/SD interface and terminating.

A3: Analyzing the command or data from CF/SD interface, and transferring them to the USB data packages that commit the USB spec.

A4: Passing the transferred USB data packages to the USB serial interface engine.

A5 Checking the USB serial interface engine for acknowledging the data package transferring or not: if no any acknowledgement, then jump to step A8 for overtime checking or not; if not overtime, then jump to step A5; if overtime, then jump to step A9.

A6: Checking the transferring or receiving is correct or not: if incorrect, then jump to step A9 for retry or not; if retry is necessary, then jump to step A4, else jump to step A10.

A7: Checking for more data to be transferred or not: if true, then jump to step A4; if false, then jump to step A10.

A8: Checking for overtime or not: if overtime, then jump to step A9, else jump to step A5.

A9: Checking for retry again or not: if true, then jump to step A4; if false, then jump to step A10.

A10: Acknowledging CF/SD interface for ensuring the data transferring/receiving is complete.

A11: Terminating all the procedures.

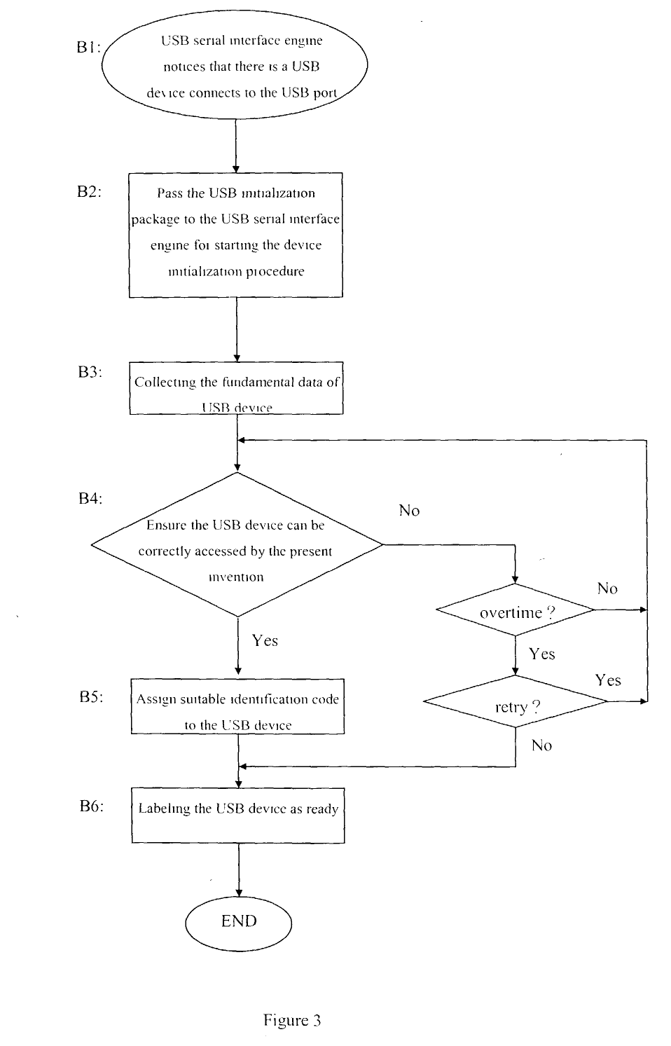

The initializing control flowchart of USB device of present invention is shown as FIG. 3, which contains several procedures as below:

B1: The USB serial interface engine notices “There is a USB device connecting to the USB port”.

B2: Passing the USB initializing data package to the USB serial interface engine for starting the device initialization procedure.

B3: Collecting the fundamental data of the USB device.

B4: Ensuring the USB device can be accessed by the interface engine correctly.

B5: Assigning suitable identification code to the USB device.

B6: Labeling the USB device is ready.

B7: Terminating all the procedures.

Of course, after partially modification for the designation, the prior example of the present invention can apply to other memory cards such as Micro Drive, MS (Memory Stock), MMC (Multimedia Card), and SM (Smart Media), etc. And, the applicable USB storage devices includes USB hard disk, USB flash disk, USB floppy disk, and USB CD-RW, and so on.

The advantages of the present invention are as follows:

Due to the small size advantage of CF and SD, most of the portable devices use them for the I/O storage media, but the memory capacity is limited. The device of the present invention is able to transfer the interface and protocol for CF or SD to the interface and protocol for USB. Therefore the portable devices are able to access all the application devices with USB interfaces via the device of the present invention. Users can reduce the cost to buy more memory cards.

To sum up, the device of the present invention can transfer data between the memory card interface and the USB interface. The device of the present invention is as a host. We may access data between any kind of memory card and every USB device (especially for USB storage devices). Therefore, when using a general portable IA device, a user can transfer the data stored in the memory card into a USB storage device of large storage space (but small size) any time. The disturbance of storage capacity limitation is avoided and the cost is reduced.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A device for transferring from a memory card interface to a USB interface, said device comprising:
a universal I/O device for simulating a signal of said memory card interface;
a micro controller for controlling said universal I/O device to access a data of said memory card interface, and for generating a USB data package;
a USB serial interface engine for transferring said USB data package to a serial data stream; and
a USB transfer/receive device for connecting to a USB storage device, and for transferring said serial data stream into a USB electrical signal.

2. A device according to claim 1 wherein said memory card includes: a CF (Compact Flash), a Micro Driver, a SD (Secure Digital), a MS (Memory Stock), a MMC (Multimedia Card), and a SM (Smart Media), etc.

3. A device according to claim 1 wherein said micro controller operates steps of:
receiving a command and said data of said memory card interface and transferring said command and said data to said USB data package;
controlling said USB serial interface engine to transfer or receive said USB data package;
executing a USB necessary error manage procedure;
executing an initialization of said USB storage device; and
controlling I/O devices of several I/O ports to commit a specification of said memory card interface.

4. A device according to claim 1 wherein said USB serial interface engine operates steps of:
transferring said serial data stream received by said USB transfer/receive device to said USB data package.

5. A device according to claim 1 wherein said USB transfer/receive device operates steps of:
transferring said USB electrical signal to said serial data stream.

6. A device according to claim 1 wherein said USB storage device contains a USB hard disk, a USB flash disk, a USB floppy disk, and a USB CD-RW, etc.
